(19) United States
(12) Patent Application Publication
(10) Pub. No.: US 2013/0110617 A1
(43) Pub. Date: May 2, 2013

(54) SYSTEM AND METHOD TO RECORD, INTERPRET, AND COLLECT MOBILE ADVERTISING FEEDBACK THROUGH MOBILE HANDSET SENSORY INPUT

(71) Applicants: Thomas PHAN, San Jose, CA (US); Won JEON, Cupertino, CA (US)

(72) Inventors: Thomas PHAN, San Jose, CA (US); Won JEON, Cupertino, CA (US)

(73) Assignee: SAMSUNG ELECTRONICS CO., LTD., Suwon City (KR)

(21) Appl. No.: 13/286,064

(22) Filed: Oct. 31, 2011

(51) Int. Cl. G06Q 30/02; G06F 19/00

(52) U.S. Cl. 705/14.43; 705/14.41; 702/19

(57) ABSTRACT

A mobile handset collects sensor data about the physiological state of the user of the handset. The mobile handset receives mobile advertising. In a deployment phase the sensor data is used to classify the user's emotional response to the advertising. A classification model may be used to map sensor data to classification labels indicative of the user's emotional response to an advertisement. That classification model may be based on associations determined during a training phase. The method, system, and apparatus permits real-time feedback to publishers and advertisers of the response of users of mobile handsets to mobile advertising.

### FIELD OF THE INVENTION

The present invention is generally related to evaluating the effectiveness of advertisements presented on a mobile handset device, such as advertisements presented on a smartphone. More particularly, the present invention is directed to determining a likely emotional state of a user in response to an advertisement displayed on the mobile handset device.

### BACKGROUND OF THE INVENTION

“Mobile advertising” generally describes the field of presenting advertisements on mobile computing devices, such as mobile handsets and smartphones. In the context of mobile advertising, graphical or text advertising creatives are displayed on a user's mobile handset. The creative is provided by an advertiser (e.g. Coca-Cola®, Toyota®, etc.) and is delivered through an advertising platform owned by a publisher (e.g. Google®, Apple®, AdBrite®, etc.).

From the viewpoint of the advertiser and the publisher, the user's response to the advertising creative is important. To the advertiser, the response can be used to evaluate the effectiveness of the current advertisement and future advertising campaigns, and to the publisher, the response can be used to evaluate the effectiveness of the advertisement delivery targeting and scheduling. Feedback on advertising will help regardless of whether the advertisement is part of a cost-per-mille, cost-per-click, cost-per-action, or other type of campaign.

Currently there are several popular ways to determine the effectiveness of an advertisement, but each of these has significant drawbacks. The click-through-rate can be determined directly via measuring the percentage of the time that a user clicks on an advertisement. However, the click-through-rate is just a proxy for ad effectiveness and may not always be a suitable metric. A more indirect approach is to determine the resulting lift of the advertisement indirectly by measuring how many more people visit stores or visit the landing page of the advertiser. However, indirect measurements are prone to incorrect assessments. Another approach is to request users to respond through customer-engagement questionnaires or polls, but such polls are susceptible to user bias and memory recall.

### SUMMARY OF THE INVENTION

An apparatus, system, method, and computer program product is described that records and interprets mobile advertising feedback. The feedback is based on sensor data of the physiological state of a user collected by a mobile handset (e.g., a smartphone) when the user views a mobile advertisement. The sensor data may be based on sensors within the mobile handset as well as sensors in close proximity to the handset. The sensor data is indicative of a physiological response of the user to an advertisement such that the sensor data also has an association with the emotional reaction of the user to the mobile advertisement. In one embodiment during a training phase test subjects provide a self-assessment of their emotional reaction to test ads and this information is combined with sensor data to create a classification model having pre-selected classification labels. In a deployment phase a mobile device may use the classification model to generate a classification label corresponding to the emotional reaction of the user of the mobile device. The classification label is then sent as feedback to another entity, such as publisher of content. Alternately, the mobile device may send a summary of relevant sensor data to another entity, such as a publisher, where this entity then classifies the summary of sensor data. Information from multiple mobile handset users may be aggregated to generate information for advertisers and publishers.

The feedback information generated from the sensor data may be used in different ways. In one embodiment the information is used to provide real time feedback to adjust aspects of an advertising program, such as the selection of advertising creatives by an advertiser or the targeting and scheduling of advertisements by a publisher.

### BRIEF DESCRIPTION OF THE DRAWINGS

FIG. 1 illustrates an exemplary system to collect mobile advertising feedback through mobile handset sensory input in accordance with one embodiment of the present invention.

FIG. 2 illustrates a training phase to form associations between classification labels and sensory data in accordance with one embodiment of the present invention.

FIG. 3 illustrates an exemplary decision tree mapping ranges of sensory data to two exemplary classification labels in accordance with one embodiment of the present invention.

FIG. 4 illustrates a deployment phase to generate real-time feedback for mobile advertising in accordance with one embodiment of the present invention.

FIG. 5 illustrates a variation of the deployment phase of FIG. 4 in accordance with one embodiment of the present invention.

### DETAILED DESCRIPTION

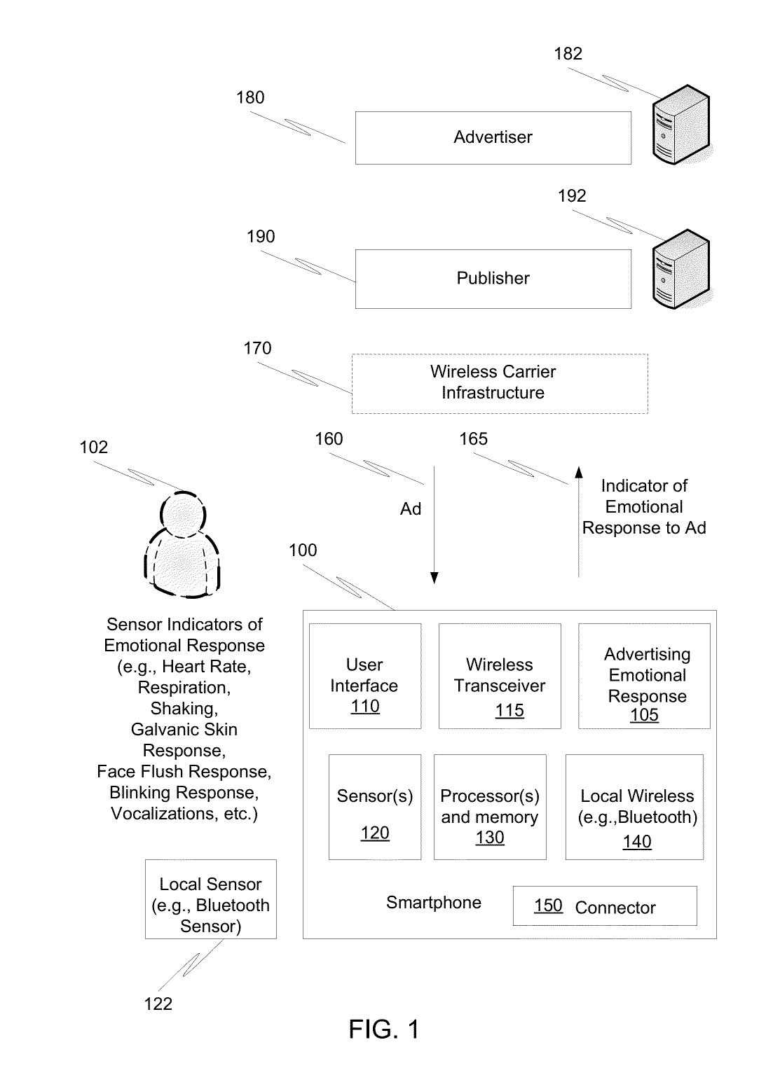

FIG. 1 is a high-level block diagram of a system to improve mobile advertising in accordance with one embodiment of the present invention. A mobile handset device 100 is capable of wirelessly accessing the Internet, where such a handset is also commonly known as a smartphone. The mobile handset device 100 receives content from a publisher 190 (e.g., Google®). The content includes embedded advertisements from advertisers 180 (e.g., Coca-Cola®), where the advertisements are also known as advertising creatives. Thus the publisher may, for example, utilize a server system 192 having one or more processors and memory to serve content and also target and schedule advertisements in the content that consumers download on their mobile handsets. Those of ordinary skill in the art will recognize that the content can also be pushed from the publisher to the consumer. The advertiser may also use a server system 182 having one or more processors and a memory to serve advertising creatives to the publisher. The publisher's content is then made available to a mobile handset device 100 using the infrastructure of a wireless carrier 170.

The mobile handset device 100 includes one or more processors and a memory 130, and sensors 120. The mobile handset device 100 includes a user interface 110 including a display capable of displaying advertisements. An advertising emotional response module 105 collects locally available sensor data from sensor(s) proximate to the mobile handset device 100, including sensors 120 within the mobile handset device 100 and any sensors 122 coupled to the mobile handset device 100 via a local wired or wireless connection.

The sensor data corresponds to the physiological response of the user 102 to an ad 160 and the mobile handset device 100 generates an indicator 165 of the emotional response to the ad based on the sensor data. The advertising emotional response module 105 may be implemented in software or firmware and include computer code residing on a memory. The advertising emotional response module 105 generates feedback 165 that is indicative of the emotional response to an ad. As examples, the feedback 165 may include a summary of relevant sensor data or an interpretation of the sensor data based on a model. It will also be understood that feedback 165 may include a marker, timestamp, or other means to associate the feedback with a particular advertisement.

In one embodiment the advertising emotional response module 105 determines a category of emotional response of the user based on a model of the user's emotional state with respect to different haptic and biometric sensor measurements from the data available from sensor(s) 120 and 122. Examples of sensor data include the user's heart rate, respiration, shaking, galvanic skin response, face flush response, blinking response, and vocalization. The categories of emotional response may be categories relevant to advertisers based on a classification model, such as whether the emotional state of the user indicates a favorable or unfavorable emotional response to an advertisement. The users' emotional responses to advertisements are identified and collected, providing a source of information for the publisher 190 and advertiser 180 to gauge the effectiveness of an ad 160. For the advertiser the feedback on the emotional response may be used to adjust an advertising campaign direction. For a publisher the feedback may be used in making decisions about advertisement targeting and scheduling.

Examples of sensor(s) 120 available in a mobile handset device capable of serving as physiological sensors of the user 102 of the mobile handset device 100 include a high-resolution front-facing color video camera, a microphone, a Global Positioning System (GPS) or other location sensor, and an accelerometer to sense motion (acceleration, shaking, and movement). Front-facing camera data may be analyzed to determine a blushing response, eye tracking (gaze location and duration as well as blinking behavior), facial expression, or other visual indicators of the emotional state of the user. There is a tradeoff between sensor quality and the ability to detect meaningful physiological responses in a wide range of user environments and noise conditions. For gaze detection exemplary minimum camera requirements are 4 Megapixels and 20 frames per second. An exemplary accelerometer implementation has an accuracy of at least 95% of true acceleration in units of meters per second squared. Analysis of motion sensor data may provide information on whether the user is shaking and/or makes abrupt movements indicative of a strong emotional response. Audio data may be analyzed to provide indicators of emotional response, such as audible gasps.

Other examples of sensor(s) 120 may include other types of compact sensors capable of being integrated into mobile handset device 100 to increase security and to support health and fitness applications, such as heart rate monitors, temperature sensors, pressure sensors, and humidity (skin dampness) sensors.

Additionally a local sensor 122 may be in communication with mobile handset device 100 via a wired connector 150. However, more generally local sensor 122 may have a local wireless connection with mobile handset device 100. For example, a user may have portable and/or wearable body sensors that are in communication with the mobile handset device via a wireless connection, such as Bluetooth®. Those of ordinary skill in the art will recognize that other wireless communication standards can be used in the place of Bluetooth®, such as the Zigbee® and Ant+™ wireless standards. In a preferred implementation, Bluetooth® is used. The Bluetooth® 4.0 standard supports wearable health sensors, such as a heart-rate profile and a thermometer profile. Other examples of wireless sensors using Bluetooth® communication include Bluetooth® enabled sensors to measure heart-rate, temperature, and galvanic skin response.

The sensor data is captured directly on the mobile handset by the advertising emotional response module 105. However, the analysis of haptic and biometric sensory inputs can be performed either on the mobile handset or a summary of the data can be sent back to the publisher or advertiser for analysis.

User privacy can be guarded by various means. For example, aspects of the user's identity could be partially or completely cloaked from publishers or advertisers to preserve privacy using a privacy protection protocol. Moreover, since advertising campaigns are often based on overall effectiveness, information aggregation techniques may be used to aggregate responses from multiple users to generate aggregated data preserving the privacy of individual user identity information. Additionally, in a preferred implementation, the user is given the option to either opt-in or opt-out of the use of the system.

The system of the present invention thus supports methods to record, interpret, and collect users' responses to delivered mobile advertising creatives. A particular user's response is captured through haptic and biometric sensory inputs of the mobile handset, such as the shaking of the handset captured via readings of the accelerometer or a change in the user's heartbeat captured via a Bluetooth®-connected heart-rate monitor. Once the data is collected, it can be analyzed by first filtering out noise from the readings and then deriving a conclusion on how the user responded to the advertisement. This analysis can be performed either on the device or at the publisher, advertiser, or by an entity (e.g. a service aiding the publisher or advertiser). A conclusion can then be aggregated across all users, with the results being used by the advertiser and the publisher.

In one embodiment of the invention, sensory input information is analyzed at a mobile handset to return an abstracted representation of the user's response, such as a representation for enjoyment, dislike, or apathy. This analysis can be performed through various methods, including but not limited to: rule-based analysis by deriving abstract responses through threshold levels of sensory input; or classification through supervised machine learning methodologies such as decision trees, Hidden Markov Models, or Support Vector Machines.

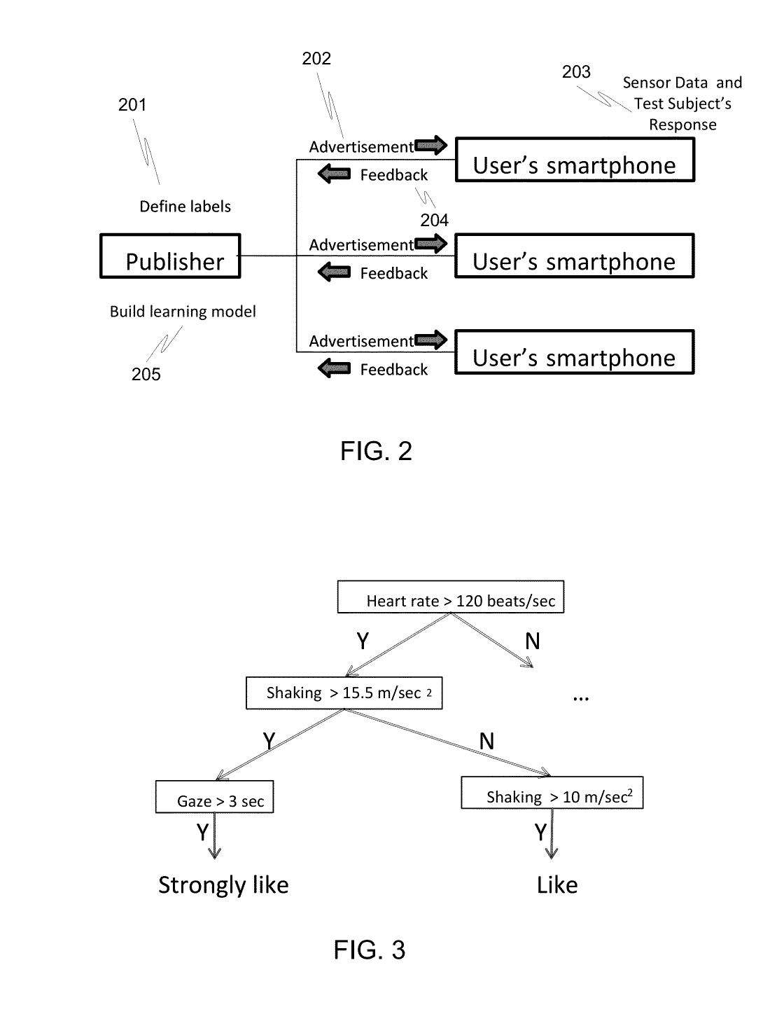

FIG. 2 shows initial steps carried out by an entity (e.g., a publisher) in a training phase to collect training data from test participants to create a statistical model to map sensory input data to a labeled response. An association model may be used to map sensory data to a high-level interpretation of emotional response including a set of classification labels such as strongly like, like, neutral (apathetic), dislike, and strongly dislike. It would be understood that the exact number and type of classification labels is an implementation detail that may be determined for a particular advertising campaign or in view of other factors.

In step 201 of FIG. 2, an entity (e.g., the publisher) defines a series of discrete classification labels to define their emotional response to an advertisement. Such labels can include, but are not limited to: strongly like, like, apathetic, dislike, and strongly dislike.

In step 202, the publisher then distributes a set of test advertisements to the participating test users (e.g., enough test advertisements to provide statistically meaningful test data).

In step 203, when a user views the ad on their smartphone, a plurality of different types of haptic and biometric information is collected from his response. Such features can include, but are not limited to: average heart beat rate (in beats per second) as measured by a Bluetooth®-connected heart rate monitor; average blinking rate (in blinks per second) as captured by a front-facing mobile handset camera and identified by software; average blush response (in RGB or CMY color space) as captured by a front-facing mobile handset camera and identified by software; and average amount of smartphone shaking (in units of meters per seconds² calculated as a Euclidean norm of 3-dimensional acceleration vectors) as measured by the mobile handset's tri-axial accelerometers. In alternative embodiments of the invention, other features may include: ribcage expansion to measure breathing, skin conductance, and eye tracking. Moreover, in addition to average information, it will be understood that the time-rate characteristics of the responses may also be analyzed.

Additionally, in one implementation, the user fills out a simple form stating their response to the advertisement using the classification labels from step 1. That is, the response includes the sensor readings and the label tagging of test subjects providing their self-assessment of their emotional response to the ad. Alternatively, it will be understood that the test subject can be asked to provide other types of reporting information for the test subject to perform a self-assessment of their emotional response (e.g., a multi-item survey form from which a corresponding classification label may be inferred).

In step 204, the user sends back the captured sensor data and the user's stated response to the publisher.

In step 205, the publisher creates a machine learning model that maps the user's captured physiological response back to the user's stated emotional response within the label classifications. Referring to FIG. 3, the model associates sensory input with a label using a classification algorithm to build associations and filter out noise. In the example of FIG. 3, the model takes the form of a decision tree having three different types of sensor data (heart rate, shaking, and gaze period) used in a model to determine ranges of sensor data in a decision tree corresponding to different emotional responses (e.g., strongly like or like).

In one embodiment the publisher uses software to run the well-known ID3 algorithm (Iterative Dichotomiser 3) to create a decision tree that will perform this mapping. The decision tree takes the form of a tree with one root connected by edges to interior vertices, which in turn are connected by edges to other vertices. The leaf vertices in this tree are the classification labels as described in step 201. The root and interior vertices contain decision statements that must be evaluated, with the result of the decision at that vertex determining which outgoing edge to take. The role of the ID3 algorithm is to create a tree that is reasonably sized and provides accurate mappings from features to classification labels.

Note that the ID3 algorithm will produce different decision trees based on different sensory data. An example portion of a produced decision tree based on some exemplary input data similar to that of FIG. 3 (but with a blink rate instead of a gaze interval) is as follows:

If (heart rate>120 beats/second)
If (shaking>15.5 meters/second²)
If (blink rate>1.3 blinks/second)

### Then STRONG LIKE

Else if (shaking>10.0 meters/second²)

### Then LIKE

In this example, the publisher implements the resulting decision tree and distributes it to the mobile handset device. In one embodiment the decision tree is distributed to mobile handset devices by distributing it into the advertising creative rendering software at the user's mobile handset. In one embodiment, the implementation is created in JavaScript and runs as part of the webpage that shows the advertising creative inside the mobile handset's browser.

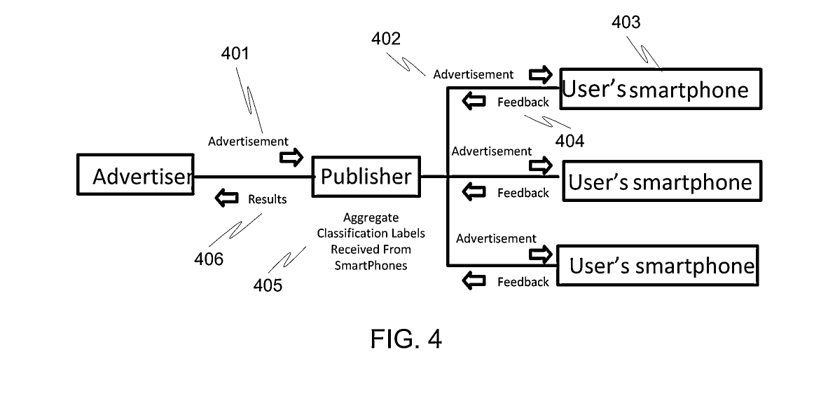

FIG. 4 shows how the decision tree is used in a deployment phase. User responses are classified to labeled responses in real-time in a way that the publisher can aggregate and give back to the advertiser.

In step 401, an advertiser provides a mobile advertising creative (in text or graphic form) to a publisher.

In step 402, the publisher schedules and assigns the display of the creative to chosen users that interact with the publisher's advertising platform.

In step 403, upon exposure to the advertising creative, the user may react to the creative. The user's response is captured through haptic or biometric sensory input. For example, the user may respond by shaking the mobile handset (which can be measured through an accelerometer) or by increasing his or her heart-rate (which can be measured through a Bluetooth®-connected heart-rate monitor). The user's response is then mapped to a classification label using the decision tree that was created previously.

In step 404, the user's response in the form of a classification label is sent back to the publisher.

In step 405, the publisher collects and aggregates the users' responses for the advertiser's creatives. As examples, aggregate information may include the average user response, the percentage of users who responded to the advertisement with a mapped classification label of “strongly like” and the percentage of users who responded with a mapped classification label of “strongly disliked.” The aggregate information, in terms of average user response, may be further stripped of personal identification information (if not performed previously) to preserve user identity privacy.

In step 406, the publisher sends the aggregate information back to the advertiser. In one embodiment the mobile handset performs the analysis of sensory input at the user's mobile handset.

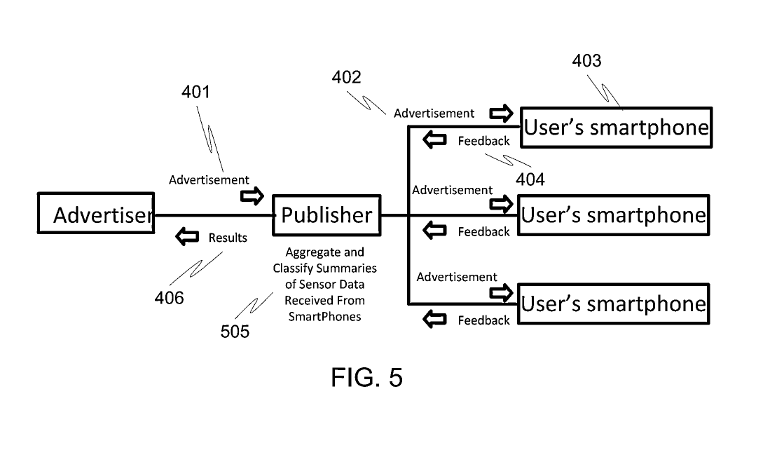

In alternative embodiment the analysis of sensory input into classification labels is performed at the publisher. Referring to FIG. 5, the system functions similar to the example of FIG. 4 except that the sensory input is collected at the mobile handset device but is not analyzed in the mobile handset device. Instead, the mobile handset device sends a summary of sensor data to the publisher. The summary of sensory data 505 may be measured, such as average accelerometer readings or average heart rate. The publisher collects and aggregates 505 the users' responses for the advertiser's creative and performs an analysis to create a classification label based on the received summaries of sensor data.

It will be understood that in principle the methods of FIGS. 4 and 5 may be combined. For example, some smartphones may provide only a summary of sensor data whereas other smartphones may provide classification labels based on the model.

While examples have been described in which the publisher performs specific roles, it will be understood that more generally some of the functions may be outsourced to another entity or entities that would be responsible for receiving feedback in a testing phase and monitoring feedback in a deployment phase. Additionally, while one embodiment of a testing phase includes asking test subjects to describe their response in terms of classification labels, it will be understood that once association models are formed they may be reused such that an association model or models having a given set of classification labels may be created by a testing entity and provided to publishers and/or advertisers.

The present invention provides numerous benefits. The user's physiological response is collected based on haptic and biometric sensory input in a smartphone environment in response to a mobile advertisement displayed on the smartphone. This physiological response is further used in a classification model to classify emotional responses to advertisements. This information provides real-time advertising feedback that is different than conventional approaches such as analyzing click-through. In turn, the feedback may be used by advertisers to adjust an advertising campaign, such as by serving test ads to gauge the emotional response of consumers and make any adjustments to the advertising creatives selected for the campaign. The publisher may also use the feedback to gather information on the effectiveness of advertisement targeting and scheduling policies.

The various aspects, features, embodiments or implementations of the invention described above can be used alone or in various combinations. The many features and advantages of the present invention are apparent from the written description and, thus, it is intended by the appended claims to cover all such features and advantages of the invention. Further, since numerous modifications and changes will readily occur to those skilled in the art, the invention should not be limited to the exact construction and operation as illustrated and described. Hence, all suitable modifications and equivalents may be resorted to as falling within the scope of the invention.

In accordance with the present invention, the components, process steps, and/or data structures may be implemented using various types of operating systems, programming languages, computing platforms, computer programs, and/or general purpose machines. In addition, those of ordinary skill in the art will recognize that devices of a less general purpose nature, such as hardwired devices, field programmable gate arrays (FPGAs), application specific integrated circuits (ASICs), or the like, may also be used without departing from the scope and spirit of the inventive concepts disclosed herein. The present invention may also be tangibly embodied as a set of computer instructions stored on a computer readable medium, such as a memory device.

What is claimed is:

1. A mobile handset device, comprising:
at least one processor and a memory;
a user interface having a display;
an advertising response module within the mobile handset device configured to collect sensor data from a set of sensors indicative of physiological response of a user of the mobile handset device;
the advertising response module monitoring sensor data associated with the physiological response of the user to an advertisement displayed on the mobile handset device and in response generate an output indicative of an emotional response of the user to the advertisement.

2. The mobile handset device of claim 1, wherein the mobile handset device includes at least one sensor of the set of sensors.

3. The mobile handset device of claim 1, wherein the set of sensors includes at least one local sensor exterior to the mobile handset device in communication with the mobile handset device via a wired or wireless connection.

4. The mobile handset device of claim 1, wherein the advertising response module is further configured to determine a classification label of the user's emotional by associating sensory inputs with a classification model and report on the classification determination to at least one of a publisher and an advertiser.

5. The mobile handset device of claim 1, wherein the advertising response module is further configured to include a training phase to determine an association between sensory data and an emotional state of the user.

6. The mobile handset device of claim 5, wherein in the training phase a user is polled on their emotional response to provide user polling data to determine an association between sensor inputs and classification labels for emotional response.

7. The mobile handset device of claim 1, wherein the advertising response module is further configured to generate a summary of sensor data that is output for a publisher or other entity to determine a classification of the user's emotional response within a pre-determined classification set.

8. The mobile handset device of claim 1, wherein the sensor inputs include sensor inputs indicative, directly or indirectly, of at least one of a heart rate, respiration rate, galvanic skin response, temperature, pressure, acceleration, motion response, skin flush response, eye blinking response, and a vocal response.

9. A method of analyzing the effectiveness of an advertising campaign, comprising:
providing advertisements to a multiplicity of mobile handset devices, where each mobile handset device is configured to record sensor data indicative of a physiological response of a user of the mobile handset device;
receiving indicator data from each of the multiplicity of mobile handset devices, the indicator data being indicative of the emotional response to a particular advertisement received by a respective mobile handset device; and
determining an aggregated emotional response classification label for at least one advertisement.

10. The method of claim 9, wherein the indicator data for at least a subset of the mobile handset devices is a summary of sensor data, the method further comprising determining an emotional classification label within a classification model based on the summary of sensor data.

11. The method of claim 9, wherein the indicator data for at least a subset of the mobile handset devices comprises an emotional classification label of a classification model determined by individual mobile handset devices.

12. The method of claim 9, further comprising in a training phase requesting test subjects to provide a self-assessment of emotional state in response to an advertisement.

13. The method of claim 12, further comprising generating a classification model mapping a set of classification labels to sensor input data.

14. The method of claim 9, further comprising generating a classification model mapping a set of classification labels to sensor input data.

15. The method of claim 9, wherein a publisher provides the advertisements to the mobile handset devices, the publisher receiving the indicator data, and the publisher determined the emotional response to advertisements.

16. The method of claim 9, wherein an advertiser receives the indicator data from publishers and the advertiser determines the emotional response to advertisements.

17. A method of analyzing the effectiveness of an advertising campaign, comprising:
receiving indicator data from a multiplicity of mobile handset devices that is indicative of the emotional response to advertisements of users of individual mobile handset devices; and
aggregating the indicator data and determining an average emotional response within the classification model for at least one advertisement.

18. The method of claim 17, wherein the indicator data includes a summary of sensor data provided by individual mobile handset devices.

19. The method of claim 18, wherein the indicator data includes classification label of the classification model generated by individual mobile handset devices.

20. The method of claim 17, further comprising providing a classification model mapping a set of emotional response classification labels to a tree of physiological sensor data ranges for a user of a mobile handset device; and

21. The method of claim 17, further comprising adjusting at least one of advertising targeting, scheduling, and creative design based on the average emotional response.

22. A computer program product comprising computer program code stored on a non-transitory computer readable medium configured when executed on the processor of a mobile handset device to implement a method comprising:
collecting sensor data from a set of sensors proximate to a mobile handset device indicative of a physiological response of a user of the mobile handset device to advertisements displayed on the mobile handset device; and
generating an output indicative of an emotional response of the user to at least one advertisement.

23. The computer program product of claim 22 further comprising computer program code to determine a classification label of the user's emotional response by associating sensory inputs with a classification model and report on the classification determination to at least one of a publisher and an advertiser.

24. The computer program product of claim 22, further comprising computer program code to determine an association between sensory data and an emotional state of the user.

25. The computer program product of claim 22, further comprising computer program code to provide user polling data to determine an association between sensor inputs and emotional response in a training phase.
